(19) United States
(12) Patent Application Publication
(10) Pub. No.: US 2020/0160408 A1
(43) Pub. Date: May 21, 2020

(54) SYSTEMS AND METHODS FOR SECURE DISTRIBUTED CROWDFUNDING

(71) Applicant: Capital One Services, LLC, McLean, VA (US)

(72) Inventors: Vijayalakshmi NATARAJAN, Glen Allen, VA (US); Arunkumar NATARAJAN, Glen Allen, VA (US)

(21) Appl. No.: 16/191,690

(22) Filed: Nov. 15, 2018

(51) Int. Cl. G06Q 30/02; G06F 21/64; G06Q 20/38; G06F 15/18

(52) U.S. Cl. CPC G06Q 30/0279; G06F 15/18; G06Q 20/381; G06F 21/64

(57) ABSTRACT

Systems and methods for secure distributed crowdfunding are provided. The one or more databases contain a plurality of user characteristics and crowdfunding proposals. The plurality of user characteristics includes one or more of transaction frequency, likelihood of interest, and transaction history. One or more processors may be configured to operate a recommendation engine to identify a crowdfunding proposal for presentation based on one or more of the plurality of user characteristics and the application of one or more thresholds to the plurality of user characteristics. The identified crowdfunding proposal may be transmitted to a client device associated with the user along with one or more offers for contribution. Upon receipt of the user's acceptance of an offer to contribute from the client device, a smart contract is generated based on the offer to contribute and at least one of account data and transaction data associated with the user.

### FIELD OF THE DISCLOSURE

The present disclosure relates to systems and methods for secure distributed crowdfunding processing.

### BACKGROUND OF THE DISCLOSURE

Current solutions for identifying and processing crowdfunding proposals are complex and incur several limitations, such as matching proposals to potentially interested funders, difficulty ascertaining potential funder preferences, ranking proposals for potential funders, preparing appropriate contracts for numerous potential funders, and potential funders having different preferences and amounts.

Accordingly, there is a need to accurately identify crowdfunding proposals likely to appeal to a potential funder, efficiently generate acceptable terms for crowdfunding proposals, and efficiently coordinate the execution and compliance of crowdfunding agreements.

### SUMMARY OF THE DISCLOSURE

In an exemplary embodiment, a crowdfunding system may include one or more databases stored in a memory. The one or more databases may contain a plurality of user characteristics and a plurality of crowdfunding proposals. The plurality of user characteristics including one or more of transaction frequency, likelihood of interest, and transaction history. The crowdfunding system may include one or more processors configured to operate a recommendation engine to identify a crowdfunding proposal from the plurality of crowdfunding proposals for presentation to a user based on one or more of the plurality of user characteristics stored in the one or more databases and the application of one or more thresholds to the plurality of user characteristics. The one or more processors may be configured to transmit the identified crowdfunding proposal to a client device associated with the user along with one or more offers for the user to contribute to the identified crowdfunding proposal. The one or more processors may be configured to upon receipt of the user's acceptance of an offer to contribute from the client device, generate a smart contract based on the offer to contribute and at least one of account data and transaction data associated with the user.

In an example embodiment, a method may include identifying, by one or more processors, a first set of data from a plurality of crowdfunding proposals based on at least one of authorization and weighting factors over a predetermined time period. The authorization and weighting factors may be associated with at least one or more of transaction frequency, likelihood of interest, and transaction history. The plurality of crowdfunding proposals and authorization and weighting factors may be contained in one or more databases stored in memory. The method may include providing, by the one or more processors, the first set of data and one or more offers to contribute to a first device associated with a user. The method may include receiving, by the one or more processors, an acceptance of an offer to contribute from the first device. The method may include creating, by the one or more processors and responsive to the receipt of an acceptance of an offer to contribute from the first device, one or more smart contracts. The method may include updating, by the one or more processors, one or more terms of the one or more smart contracts based on one or more changes of at least one of account data and transaction data associated with the user. The method may include collecting, by the one or more processors, funds as required by at least one of the one or more smart contracts and updated one or more smart contracts.

In an example embodiment, a computer-readable medium storing instructions that, when executed by at least one processor, cause the at least one processor to provide, based on received login information, one or more identified crowdfunding proposals from a plurality of crowdfunding proposals to one or more user devices based on a plurality of parameters, the plurality of parameters including one or more of transaction frequency, likelihood of interest, and transaction history. Further, the computer-readable medium storing instructions that, when executed by the at least one processor, cause the at least one processor to provide, to the one or more user devices, one or more ranked predictive suggestions associated with the plurality of crowdfunding proposals via machine learning based on the plurality of parameters. Also, the computer-readable medium storing instructions that, when executed by the at least one processor, cause the at least one processor to create a smart contract based on receipt of an acceptance of an offer to contribute to at least one of the one or more ranked predictive suggestions and the one or more identified crowdfunding proposals. Further, the computer-readable medium storing instructions that, when executed by the at least one processor, cause the at least one processor to exchange one or more cryptocurrencies for the offer to contribute.

### BRIEF DESCRIPTION OF THE DRAWINGS

Various embodiments of the present disclosure, together with further objects and advantages, may best be understood by reference to the following description taken in conjunction with the accompanying drawings, in the several figures of which like reference numerals identify like elements, and in which:

FIG. 1 depicts a block diagram of a system configured to provide secure distributed crowdfunding according to an example embodiment;

FIG. 2 depicts a flow diagram illustrating a method for providing secure distributed crowdfunding according to an example embodiment;

FIGS. 3A-3B depict diagrams illustrating preferential matching for providing secure distributed crowdfunding according to an example embodiment;

FIGS. 4A-4B depict diagrams illustrating smart contract generation for providing secure distributed crowdfunding according to an example embodiment;

FIG. 5 depicts a flow diagram illustrating a method of operation of a recommendation engine for providing secure distributed crowdfunding according to an example embodiment; and

FIG. 6 depicts database schema for providing secure distributed crowdfunding according to an example embodiment.

### DETAILED DESCRIPTION

According to the various embodiments of the present disclosure, systems and methods employ preference matching and smart contract generation to provide secure distributed crowdfunding. As disclosed herein, a crowdfunding proposal may be identified from a plurality of crowdfunding proposals for presentation to a client or user device based on one or more of a plurality of user characteristics. The client or user device may receive the identified crowdfunding proposal along with one or more offers for the user to contribute to the identified crowdfunding proposal. Upon receipt of the user's acceptance of an offer to contribute from the client device, a smart contract may be generated based on the offer to contribute and at least one of account data and transaction data. Further, one or more terms of the generated smart contract may be dynamically updated based on one or more changes associated with at least one of the account and transaction data. Upon execution of the smart contract, one or more cryptocurrencies may be exchanged for the offer to contribute. In this manner, a crowdfunding platform is configured to expose the crowdfunding proposal to one or more users by employing preference matching and smart contract generation so as to supply funds to the owner of the crowdfunding proposal. When the required capital associated with the identified crowdfunding proposal is met, for example, by complying with a predetermined threshold amount and time duration associated with the crowdfunding proposal, the funds associated with the required capital may be transmitted or otherwise provided to the small business owner. In some examples, the generation of the smart contract provides an easy and expedited manner for users to reach an agreement for payment of dividend/profit-sharing by the small business owner. Exemplary embodiments of crowdfunding proposals include business ventures, such as a starting a new business or expanding an existing business, gift-giving or charitable ventures, such as making a donation to a charity or person in need, or payment of educational expenses.

In one example, a first user may be identified to possess a good standing of credit history. The first user may purchase coffee more than a threshold number, e.g., ten times a week at one or more coffee shops, spending more than $50 a week. The purchase of coffee by the first user may comprise about 25% of the first user's overall monthly bill. A second user may also be identified to possess a good standing of credit history. The second user may purchase coffee about 3 times a week at one or more coffee shops, spending $30 a week. The purchase of coffee by the second user may comprise about 5% of the second user's overall monthly bill. The frequency of visits, actual money spent, percentage of overall spend at a designated merchant type may be the one or weighting factors that are used to provide one or more crowdfunding proposals to opt-in customers or users. By utilizing the one or more weighting factors and determining compliance with one or more thresholds, via the systems and methods described herein, the first user may be offered one or more crowdfunding proposals relating to the first user's demonstrated interest in coffee, such as crowdfunding proposals for a coffee shop, coffee distribution, coffee marketing, or distribution, or other coffee-related proposals. In contrast, the second user may be judged to have insufficient interest in coffee-related crowdfunding proposals, and accordingly may not be offered proposals.

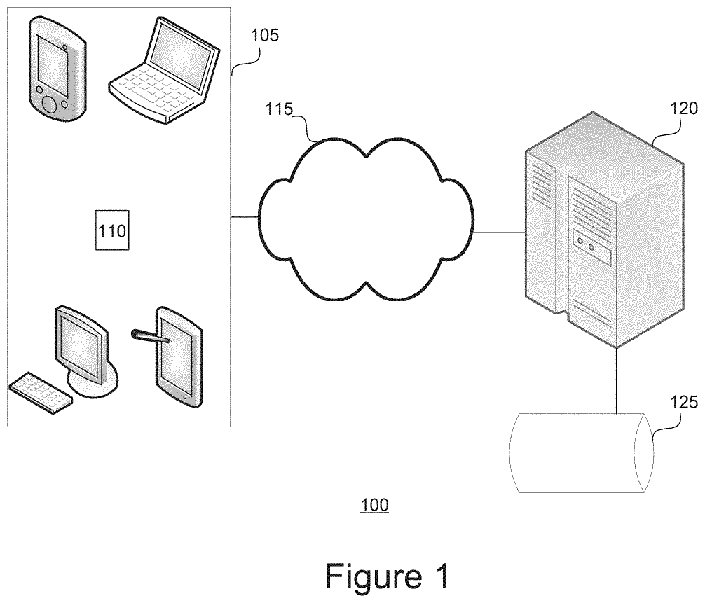

FIG. 1 illustrates a system 100 configured to provide secure distributed crowdfunding according to an example of the present disclosure. As further discussed below, system 100 may include client device 105, network 115, server 120, and database 125. Although FIG. 1 illustrates single instances of the components, system 100 may include any number of components, including one or more processors.

As shown in FIG. 1, client device 105, or end node 105, may be a network-enabled computer. As referred to herein, a network-enabled computer may include, but is not limited to: e.g., a computer device, or communications device including, e.g., a server, a network appliance, a personal computer, a workstation, a mobile device, a phone, a handheld PC, a personal digital assistant, a thin client, a fat client, an Internet browser, or other device. Client device 105 also may be a mobile device; for example, a mobile device may be a smart phone, a laptop computer, a tablet computer, a wearable device, and/or any other like mobile device or portable computing device.

In various examples according to the present disclosure, client device 105 of system 100 may execute one or more applications 110, such as software applications, that enable, for example, network communications with one or more components of system 100 and transmit and/or receive data. Client device 105 may be in communication with one or more servers 120 via one or more networks 115, and may operate as a respective front-end to back-end pair with server 120. Client device 105 may transmit, for example from a mobile device application 110 executing on client device 105, one or more requests to server 120. The one or more requests may be associated with retrieving data from server 120. Server 130 may receive the one or more requests from client device 105. Based on the one or more requests from client device 105, server 130 may be configured to retrieve the requested data from one or more databases 125. Based on receipt of the requested data from one or more databases 125, server 120 may be configured to transmit the received data to client device 105, the received data being responsive to one or more requests.

In various examples, one or more databases 125 may comprise a machine learning processor or model or algorithm which may be configured using native knowledge based on one or more of customer spend activity and continuous learning. One or more databases 125 may be optimized for fast retrieval of one or more relevant crowdfunding proposals as and when users perform authorizations at merchant locations, as further explained. For example, database 125 may be configured and optimized for fast retrieval of one or more crowdfunding proposals. In some examples, the optimization for fast retrieval may be based on one or more select parameters, such as a purchase authorization.

In some examples, one or more machine learning algorithms may be configured to predict a likelihood of one or more crowdfunding proposals. For example, the one or more machine learning algorithms may be configured to predict a likelihood of one or more crowdfunding proposals that a customer, for example an opted-in customer, is likely to provide funds towards, which may be mapped to a current authorization and in real-time use the authorization data to trigger one or more proposal offers. In one example, based on spending pattern and weighting, it may be determined that a customer is likely to favor crowdfunding a florist start-up. However, one or more potential crowdfunding proposals are made or presented to the customer right when the customer is visiting a florist and making a purchase. This will increase the likelihood of the customer funding a proposal because of the recent visit and purchase associated with the florist start-up. As mentioned above, the one or more machine learning algorithms may be configured to predict a likelihood, but the crowdfunding proposals are retrieved by a purchase or an event or action otherwise triggering the purchase. Exemplary machine learning algorithms may include neural networks, gradient boosting machine, logistic regression, or a combination thereof. However, it is understood that other machine learning algorithms may be utilized.

Server 120 may include one or more processors, which are coupled to memory. Server 120 may be configured as a central system, server or platform to control and call various data at different times to execute a plurality of workflow actions. Server 120 may be configured to connect to database 125. Server 120 may be connected to at least one client device 105.

Network 115 may be one or more of a wireless network, a wired network or any combination of wireless network and wired network, and may be configured to connect client device 105 to server 120. For example, network 115 may include one or more of a fiber optics network, a passive optical network, a cable network, an Internet network, a satellite network, a wireless LAN, a Global System for Mobile Communication (GSM), a Personal Communication Service (PCS), a Personal Area Network (PAN), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g, Bluetooth network, or any other wired or wireless network for transmitting and receiving a data signal.

In addition, network 115 may include, without limitation, telephone lines, fiber optics, IEEE Ethernet 902.3, a wireless network, a wide area network (WAN), a wireless personal area network (WPAN), a local area network (LAN), a body area network (BAN), a global network such as the Internet, a cellular network, or any combination thereof. Network 115 may utilize one or more protocols of one or more network elements to which they are communicatively coupled. Network 115 may translate to or from other protocols to one or more protocols of network devices. Although network 115 is depicted as a single network, it should be appreciated that according to one or more examples, network 115 may comprise a plurality of interconnected networks, such as, for example, the Internet, a service provider's network, a cable television network, corporate networks, such as credit card association networks, and home networks.

In various examples, network 115 may be configured to provide data communication between a client device 105 and server 120 and between the client devices 105. For example, data may be communicated between client devices 105 and server 120 through the Internet or other network, and data may be communicated directly between client devices 105 and/or one or more databases 125 without passing through server 120. Accordingly, network 115 may be one or more of the Internet, Near Field Communication (NFC), Radio Frequency Identification (RFID), Bluetooth, Wi-Fi, and/or the like. Client devices 105 may be same or different devices.

As described herein, the users of client device 105 may comprise account holders, such as credit card holders, debit card holders, savings account holders, or brokerage account holders. In effect, the account holders may serve as venture capitalists. In some examples, system 100 is configured for small businesses or small business owners seeking $10,000-$50,000 funding for a crowdfunding proposal. System 100 may be configured to provide a platform so as to enable the account holder to access, view, and contribute to the crowdfunding proposal. System 100 may be configured to allow the account holder to select and designate their willingness to contribute or otherwise invest in the crowdfunding proposal based on a plurality of user characteristics or preferences. In some examples, the plurality of user characteristics may be compiled from data collected from a plurality of users at database 125.

In some examples, users of client device 105 may have to first opt-in in order to view the crowdfunding proposals. For example, a user of client device 105 may opt-in via subscription or login process by providing authentication information through a user or client device 105. Upon validation of the authenticated information from user or client device 105, or upon authenticating the user or client device 105, the crowdfunding proposals may be provided to the user or client device 105. In other examples, users of client device 105 may not be required to opt-in and provide authentication information in order to view the crowdfunding proposals. In some examples, authentication of the user or client device 105 may not be required for the user to view the crowdfunding proposals. For example, a user may be notified via a notification, such as a pop-up notification, that appears on the user or client device 105 indicative of the crowdfunding proposals (not shown).

Regarding preference matching, the one or more processors of system 100 may be configured to operate a recommendation engine that may provide both recommendations of crowdfunding proposals for the user and recommendations of offers in general based on a plurality of user characteristics. The recommendation engine may be configured to present the crowdfunding proposal and process an acceptance of an offer to contribute in a discrete and targeted manner to specific users. In one example, the plurality of characteristics may include one or more of transaction frequency, such as how often a particular transaction takes place over a predetermined time period that may be associated with the crowdfunding proposal; likelihood of interest, such as a level of interest expressed by the user over a predetermined time period that may be associated with the crowdfunding proposal; and transaction history, such as corresponding date and time stamps over a predetermined time period that may be associated with the crowdfunding proposal. Examples of other characteristics may include user responses to surveys; the amount being charged; and spikes, patterns, and/or trends of spending or transaction types (e.g. a user who has never once purchased a particular product now charges his or her card for the particular product). The recommendation engine may use one or more of the plurality of characteristics to identify and select crowdfunding proposals for presentation to a user, and the recommendation engine may apply one or more thresholds to utilized characteristics. In some examples, system 100 is configured to adjust one or more of the start date, end date, payment mode, and payment schedule associated with the crowdfunding proposal. In some examples, the thresholds may comprise at least one of authorization factors and weighting factors over a predetermined time period. The plurality of user characteristics may include characteristics attributable to a specific user and may further include a collection of characteristics compiled from a plurality of users.

In some examples, the recommendation engine may be configured to filter out users based on one or more of the plurality of user characteristics. For example, out of ten crowdfunding proposals, three may be recommended to a user of client device 105 based on transaction history of the user. In some examples, crowdfunding proposals may be recommended and based on one or more of transaction frequency, such as how often a particular transaction takes place over a predetermined time period that may be associated with each of the crowdfunding proposals; and likelihood of interest, such as a level of interest expressed by the user over a predetermined time period that may be associated with each of the crowdfunding proposals. Examples of other characteristics include user responses to surveys; the amount being charged; and spikes, patterns, and/or trends of spending or transaction types (e.g. a user who has never once purchased a particular product now charges his or her card for the particular product). In this manner, one or more predictive suggestions associated with crowdfunding proposals may be made, undesirable crowdfunding proposals are identified and not presented to the user of client device 105, and the user of client device 105 may be matched with one or more desirable crowdfunding proposals based on the application of one or more thresholds to the plurality of user characteristics. As discussed above, by recognizing one or more patterns based on the one or more predictive suggestions to match with the one or more desirable crowdfunding proposals, machine learning may be employed to predict one or more suggestive crowdfunding proposals that are presented to the user of client device 105.

In some examples, the recommendation engine may be configured to identify a plurality of crowdfunding proposals, rank the plurality of crowdfunding proposals based on one or more of the plurality of user characteristics, and transmit the plurality of the ranked crowdfunding proposals to client device 105. The highest ranked crowdfunding proposal may be transmitted to client device 105 first. For example, the plurality of ranked crowdfunding proposals may be transmitted sequentially to client device 105 or in a predetermined arrangement.

After preference matching, the smart contract may be generated. The one or more processors of system 100 may be configured to create one or more smart contracts. In some examples, the one or more smart contracts may be between the user of client device 105, such as an account holder, and the small business owner. For example, payment to the user of client device 105 may comprise one or more cryptocurrencies in exchange for the offer to contribute. The payment may comprise a single payment or a plurality of periodic payments (e.g. weekly, bi-weekly, monthly, etc.). Different modes of payment may be made by user of client device 105. In one example, the one or more cryptocurrencies may comprise one or more bitcoin transactions through blockchain implementation. In some examples, the one or more processors of system 100 may be configured to exchange one or more cryptocurrencies for the acceptance of the offer to contribute to the crowdfunding proposal. In some examples, prior to transfer, currency may be converted to a cryptocurrency to enable cryptocurrency processing and exchange from a credit card account or bank account. In some examples, conversion may be performed after establishing communication with one or more servers, such as a trading platform, such that the one or more servers may be configured to receive a request from the client device 105 to process conversion to a cryptocurrency based on corresponding conversion rates, cryptocurrency availability and liquidity, and other transaction-related cryptocurrency data. Thus, the client device may be configured to enable payment from a user account, such as a bank or credit card account, so as to process a cryptocurrency transaction to perform one or more modes of payment.

Additionally, the smart contract may include one or more terms that are dynamically updated based on one or more changes associated with one or more of the account data and the transaction data prior to the receipt of the user's acceptance. In some examples, the ability to dynamically update one or more terms of the smart contract allows the contract to include or otherwise integrate data newly available data in order to create the most accurate, complete, and recent version of the smart contract. The dynamic updating of contracts may be performed before the user accepts the contract. The one or more processors of system 100 may be configured to collect funds upon execution of the smart contract.

In one example, a crowdfunding proposal by a small business owner may seek $10,000 to open up a coffee shop via crowdfunding that services both small business owners and account holders. For example, 100 lenders, such as users of client device 105, may each contribute $100 so as to satisfy the threshold amount. The $100 may be presented as a charge to a user of client device 105. When the target threshold amount has been reached, the $10,000 may be released to the small business owner. As a consequence, the risk for lending via crowdfunding may be mitigated or reduced, and small business owners will no longer find it difficult to obtain secure venture capitalists for a small venture. Thus, there exists the incentive for a user of client device 105 to invest in a small venture. Moreover, there is an increased likelihood that small dollar investments are available to the venture capitalists' radars.

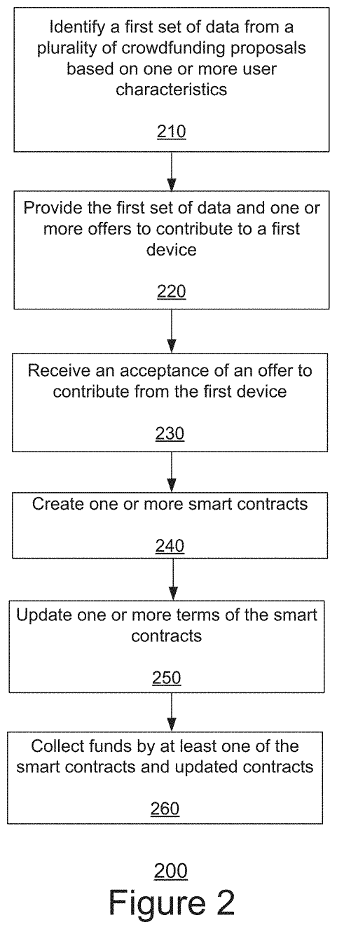

FIG. 2 illustrates a method 200 for providing secure distributed crowdfunding according to an example of the present disclosure. As explained below, method 200 may reference same or similar components of system 100. For example, as described herein, the users of a client device (similar to client device 105 as described above with respect to FIG. 1) may comprise account holders. In effect, the account holders may serve as venture capitalists. In some examples, method 200 may be configured for small businesses or small business owners seeking $10,000-$50,000 funding for a crowdfunding proposal. Method 200 may be configured to provide a platform so as to enable the account holder to access, view, and contribute to the crowdfunding proposal.

At block 210, a first set of data may be identified, by one or more processors, from a plurality of crowdfunding proposals based on one or more user characteristics (similar to one or more processors as described above with respect to FIG. 1). Method 200 may be configured to allow the account holder to select and designate their willingness to contribute or otherwise invest in the crowdfunding proposal based on a plurality of user characteristics or preferences. In some examples, the plurality of user characteristics may be compiled from data collected from a plurality of users at a database (similar to database 125 as described above with respect to FIG. 1).

As further described herein, regarding preference matching, the one or more processors may be configured to operate a recommendation engine that may provide both the best recommendations of crowdfunding proposals to the user and best offers overall based on a plurality of user characteristics. Unlike conventionally presenting a crowdfunding proposal to everyone with access, the recommendation engine may be configured to present the crowdfunding proposal and process an acceptance of an offer to contribute in a discrete and specific manner to users that is more targeted. In one example, the plurality of characteristics may include thresholds associated with at least one or more of transaction frequency, such as how frequent a particular transaction takes place over a predetermined time period that may be associated with the crowdfunding proposal; likelihood of interest, such as a level of interest expressed by the user over a predetermined time period that may be associated with the crowdfunding proposal; and transaction history, such as corresponding date and time stamps over a predetermined time period that may be associated with the crowdfunding proposal. Examples of other characteristics may include user responses to surveys; the amount being charged; and spikes, patterns, and/or trends of spending or transaction types (e.g. a user who has never once purchased a particular product now charges his or her card for the particular product). In some examples, the one or more processors may be configured to adjust one or more of the start date, end date, payment mode, and payment schedule associated with the crowdfunding proposal. In some examples, the thresholds may comprise at least one of authorization factors and weighting factors over a predetermined time period.

In some examples, users of the client device may have to first opt-in in order to view the crowdfunding proposals. For example, a user of the client device may opt-in via subscription or login process by providing authentication information through the client device. Upon validation of the authenticated information from the user or client device, or upon authenticating the user or client device, the crowdfunding proposals may be provided to the user or client device. In other examples, a user of the client device may not be required to opt-in and provide authentication information in order to view the crowdfunding proposals. In some examples, authentication of the user or client device may not be required for the user to view the crowdfunding proposals. For example, a user may be notified via a notification, such as a pop-up notification, that appears on the user or client device indicative of the crowdfunding proposals (not shown). In some examples, after a user has at least a predetermined time of good standing, the pop-up notification may appear when the user is engaged in an online or active session (i.e., after logging in) that is configured to interact with the one or more processors.

At block 220, the first set of data and one or more offers to contribute to the identified crowdfunding proposal may be provided by the one or more processors to a first device, such as the client device. In some examples, the one or more processors may be configured to allow the user of the first device to select and designate their willingness to contribute or otherwise invest in the crowdfunding proposal based on a plurality of user characteristics or preferences. In some examples, the plurality of user characteristics may be compiled from data collected from a plurality of users at one or more databases.

In some examples, the user of the first device may be required to first opt-in in order to view the crowdfunding proposals. For example, a user of the first device may opt-in via subscription or login process by providing authentication information through the first device. Upon validation of the authenticated information from the first device, or upon authenticating the first device, the one or more crowdfunding proposals may be provided to the first device.

In other examples, the user of the first device may not be required to opt-in and provide authentication information in order to view the one or more crowdfunding proposals. In some examples, authentication of the first device may not be required for the user to view the one or more crowdfunding proposals. For example, a user may be notified via a notification, such as a pop-up notification, that appears on the first device indicative of the one or more crowdfunding proposals (not shown).

In some examples, the one or more processors may be configured to operate a recommendation engine that may provide both recommendations of crowdfunding proposals for the user and recommendations of offers in general based on a plurality of user characteristics. The recommendation engine may be configured to present the crowdfunding proposal and process an acceptance of an offer to contribute in a discrete and targeted manner to specific users. In one example, the plurality of characteristics may include one or more of transaction frequency, such as how often a particular transaction takes place over a predetermined time period that may be associated with the crowdfunding proposal; likelihood of interest, such as a level of interest expressed by the user over a predetermined time period that may be associated with the crowdfunding proposal; and transaction history, such as corresponding date and time stamps over a predetermined time period that may be associated with the crowdfunding proposal. Examples of other characteristics may include user responses to surveys; the amount being charged; and spikes, patterns, and/or trends of spending or transaction types (e.g. a user who has never once purchased a particular product now charges his or her card for the particular product). The recommendation engine may use one or more of the plurality of characteristics to identify and select crowdfunding proposals for presentation to a user, and the recommendation engine may apply one or more thresholds to utilized characteristics.

In some examples, the one or more processors may be configured to adjust one or more of the start date, end date, payment mode, and payment schedule associated with the crowdfunding proposal. In some examples, the thresholds may comprise at least one of authorization factors and weighting factors over a predetermined time period. The plurality of user characteristics may include characteristics attributable to a specific user and may further include a collection of characteristics compiled from a plurality of users.

In some examples, the recommendation engine may be configured to filter out users based on one or more of the plurality of user characteristics. For example, out of ten crowdfunding proposals, three may be recommended to a user of the first device based on transaction history of the user. In some examples, the three crowdfunding proposals that are provided may be based on one or more of transaction frequency, such as how often a particular transaction takes place over a predetermined time period that may be associated with each of the crowdfunding proposals; and likelihood of interest, such as a level of interest expressed by the user over a predetermined time period that may be associated with each of the crowdfunding proposals. Examples of other characteristics that the three crowdfunding proposals may be based on include user responses to surveys; the amount being charged; and spikes, patterns, and/or trends of spending or transaction types (e.g. a user who has never once purchased a particular product now charges his or her card for the particular product). In this manner, one or more predictive suggestions associated with crowdfunding proposals may be made, undesirable crowdfunding proposals are identified and not presented to the user of the first device, and the user of the first device may be matched with one or more desirable crowdfunding proposals based on the application of one or more thresholds to the plurality of user characteristics. By recognizing one or more patterns based on the one or more predictive suggestions to match with the one or more desirable crowdfunding proposals, machine learning may be employed to predict one or more suggestive crowdfunding proposals that are presented to the user of the first device.

In some examples, the recommendation engine may be configured to identify a plurality of crowdfunding proposals, rank the plurality of crowdfunding proposals based on one or more of the plurality of user characteristics, and transmit the plurality of the ranked crowdfunding proposals to the first device. The highest ranked crowdfunding proposal may first be transmitted to the first device. For example, the plurality of ranked crowdfunding proposals may be transmitted sequentially to the first device or in a predetermined arrangement.

At block 230, an acceptance of an offer to contribute may be received at the one or more processors from the first device. In some examples, the one or more processors may be configured to receive acceptance of an offer to contribute. For example, the receipt of acceptance of offer to contribute may be transmitted from the first device. In some examples, the acceptance of offer to contribute may be associated with the identified crowdfunding proposal based on one or more user characteristics and application of one or more thresholds to the one or more user characteristics.

At block 240, one or more smart contracts may be created by the one or more processors responsive to the acceptance of the offer to contribute. In some examples, the one or more smart contracts may be between the user of first device, such as an account holder, and the small business owner. For example, payment to the user of first device may comprise one or more cryptocurrencies in exchange for the offer to contribute. The payment may comprise a single payment or a plurality of periodic payments (e.g. weekly, bi-weekly, monthly, etc.). Different modes of payment may be made by user of first device. In one example, the one or more cryptocurrencies may comprise one or more bitcoin transactions through blockchain implementation. In some examples, the one or more processors may be configured to exchange one or more cryptocurrencies for the acceptance of the offer to contribute to the crowdfunding proposal. In some examples, prior to transfer, currency may be converted to a cryptocurrency to enable cryptocurrency processing and exchange from a credit card account or bank account. In some examples, conversion may be performed after establishing communication with one or more servers, such as a trading platform, such that the one or more servers may be configured to receive a request from the client device to process conversion to a cryptocurrency based on corresponding conversion rates, cryptocurrency availability and liquidity, and other transaction-related cryptocurrency data. Thus, the client device may be configured to enable payment from a user account, such as a bank or credit card account, so as to process a cryptocurrency transaction to perform one or more modes of payment.

At block 250, one or more terms of the one or more smart contracts may be updated by the one or more processors based on one or more changes of at least one of account data and transaction data associated with the user. In some examples, the one or more smart contracts may include one or more terms that are dynamically updated based on one or more changes associated with one or more of the account data and the transaction data prior to the receipt of the user's acceptance. In some examples, the ability to dynamically update one or more terms of the smart contract provides the benefit of changing the contract to include or otherwise integrate data, in real-time, so as to represent the most accurate, complete, and recent version of the smart contract before the user accepts it.

At block 260, funds as required by at least one of the one or more smart contracts and updated one or more smart contracts may be collected by the one or more processors.

In some examples, the crowdfunding proposal may comprise a business venture and method 200 may further comprise collecting, by the one or more processors, funds from the business venture in accordance with the one or more smart contracts. In some examples, method 200 may further comprise distributing, by the one or more processors, the funds collected from a crowdfunding proposal, such as a business venture, to an account associated with the user. In some examples, method 200 may further comprise distributing, by the one or more processors, a predetermined percentage of the funds collected from the crowdfunding proposal to an account not associated with the user.

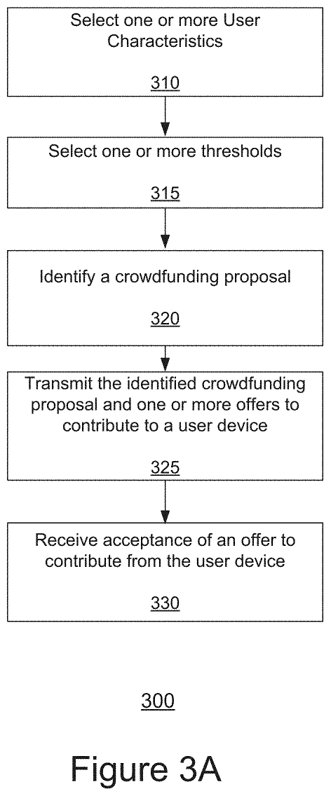

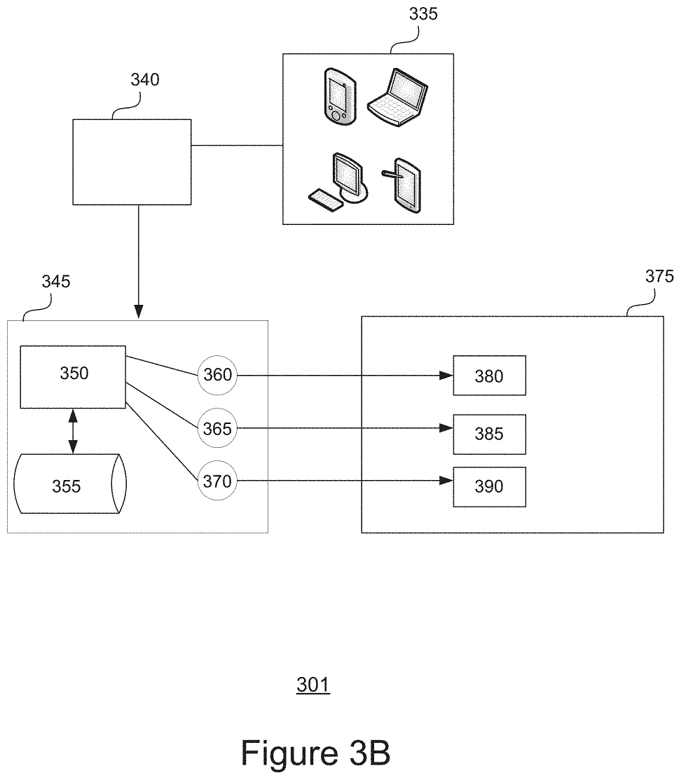

FIG. 3A illustrates an example method 300 for preferential matching. The preferential matching may reference same or similar components and/or processes as described above with respect to FIG. 1 and FIG. 2.

At block 310, one or more processors may be configured to select one or more user characteristics. For example, the plurality of user characteristics may comprise one or more of transaction frequency, likelihood of interest, and transaction history. The one or more plurality of user characteristics may be stored in or retrieved from one or more databases. The plurality of user characteristics may include characteristics attributable to a specific user and may further include a collection of characteristics compiled from a plurality of users. The one or more characteristics may be used to identify a crowdfunding proposal from a plurality of crowdfunding proposals.

At block 315, the one or more processors may be configured to select one or more thresholds. In some examples, the thresholds may comprise at least one of authorization factors and weighting factors over a predetermined time period. The one or more thresholds and its application may be used to identify a crowdfunding proposal from a plurality of crowdfunding proposals.

At block 320, at least one crowdfunding proposal may be identified, by one or more processors configured to operate a recommendation engine, from a plurality of crowdfunding proposals based on the selected one or more user characteristics and application of the selected one or more thresholds to the selected one or more user characteristics. The one or more processors may use one or more of the plurality of characteristics to identify and select crowdfunding proposals for presentation to a user, and the one or more processors may apply one or more thresholds to utilized characteristics. In some examples, the one or more processors may be configured to adjust one or more of the start date, end date, payment mode, and payment schedule associated with the crowdfunding proposal. In some examples, the thresholds may comprise at least one of authorization factors and weighting factors over a predetermined time period. The plurality of user characteristics may include characteristics attributable to a specific user and may further include a collection of characteristics compiled from a plurality of users.

At block 325, the identified crowdfunding proposal and one or more offers to contribute may be transmitted to a user device. In some examples, the one or more processors may be configured to identify a plurality of crowdfunding proposals, rank the plurality of crowdfunding proposals based on one or more of the plurality of user characteristics, and transmit the plurality of the ranked crowdfunding proposals to the user device. The highest ranked crowdfunding proposal may first be transmitted to the user device. For example, the plurality of ranked crowdfunding proposals may be transmitted sequentially to the user device or in a predetermined arrangement.

At block 330, an acceptance of an offer to contribute to the identified crowdfunding proposal may be received at the one or more processors from the user device. In some examples, the one or more processors may be configured to receive acceptance of an offer to contribute. For example, the receipt of acceptance of offer to contribute may be transmitted from the user device. In some examples, the acceptance of offer to contribute may be associated with the identified crowdfunding proposal based on one or more user characteristics and application of one or more thresholds to the one or more user characteristics. Upon receipt of the acceptance of the offer to contribute to the identified crowdfunding proposal, a contract such as a smart contract may be created, as further described herein.

In some examples, the recommendation engine may be configured to filter out users or customers based on one or more of the plurality of user characteristics. For example, out of ten crowdfunding proposals, three may be recommended to a user of a client device based on transaction history of the user. In this manner, one or more predictive suggestions associated with crowdfunding proposals may be made, undesirable crowdfunding proposals are identified and not presented to the user of the client device, and the user of the client device may be matched with one or more desirable crowdfunding proposals based on the application of one or more thresholds to the plurality of user characteristics. One or more machine learning processes may be employed to predict one or more suggestive crowdfunding proposals that are presented to the user of the client device. In some examples, the machine learning model may learn, as a part of continuous learning, how a particular customer has reacted or responded to one or more previous crowdfunding offers to determine a likelihood of future crowdfunding offers

In some examples, the recommendation engine may be configured to identify a plurality of crowdfunding proposals, rank the plurality of crowdfunding proposals based on the plurality of user characteristics, and transmit the plurality of the ranked crowdfunding proposals to the client device. The highest ranked crowdfunding proposal may be transmitted to the client device first. For example, the plurality of ranked crowdfunding proposals may be transmitted sequentially to the client device or in a predetermined arrangement.

In other examples, the recommendation engine may be configured to identify a plurality of crowdfunding proposals, rank the plurality of crowdfunding proposals based on transaction data, and transmit the plurality of the ranked crowdfunding proposals to the client device. The highest ranked crowdfunding proposal may be transmitted to the client device first. For example, the plurality of ranked crowdfunding proposals may be transmitted sequentially to the client device or in a predetermined arrangement.

FIG. 3B illustrates a system 301 according to an example of the present disclosure configured for preference matching. As explained below, system 301 may reference same or similar components of system 100.

System 301 may comprise one or more client devices 335 (similar to client device 105 as described above with respect to FIG. 1). As described above, one more client devices 335 may be required to comply with opt-in service 340. For example, users of the client device may have to first opt-in in order to view the crowdfunding proposals. For example, a user of client device 335 may opt-in via subscription or login process 340 by providing authentication information through client device 335. Upon validation of the authenticated information from the user or client device 335, or upon authenticating the user or client device 335, the crowdfunding proposals may be provided to the user or client device 335. In other examples, a user of client device 335 may not be required to opt-in and provide authentication information in order to view the crowdfunding proposals. In some examples, authentication of the user or client device 335 may not be required for the user to view the crowdfunding proposals. For example, a user may be notified via a notification, such as a pop-up notification, that appears on client device 335 indicative of the crowdfunding proposals (not shown).

System 301 may comprise a preference matching system 345, which may include a recommendation engine 350 and a database 355. As described above, one or more processors may be configured to operate as recommendation engine 350. Recommendation engine 350 may be configured to filter out users or customers of client device 335 based on one or more of the plurality of user characteristics. For example, out of ten crowdfunding proposals, three may be recommended to a user of client device 335 based on transaction history of the user. In this manner, one or more predictive suggestions associated with crowdfunding proposals may be made, undesirable crowdfunding proposals are identified and not presented to the user of client device 335, and the user of the client device 335 may be matched with one or more desirable crowdfunding proposals based on the application of one or more thresholds to the plurality of user characteristics. Machine learning may be employed to predict one or more suggestive crowdfunding proposals that are presented to the user of client device 335.

In some examples, recommendation engine 350 may be configured to identify a plurality of crowdfunding proposals, rank the plurality of crowdfunding proposals based on the plurality of user characteristics, and transmit the plurality of the ranked crowdfunding proposals to client device 335. The highest ranked crowdfunding proposal may be transmitted to client device 335 first. For example, the plurality of ranked crowdfunding proposals may be transmitted sequentially to client device 335 or in a predetermined arrangement.

In other examples, recommendation engine 350 may be configured to identify a plurality of crowdfunding proposals, rank the plurality of crowdfunding proposals based on transaction data, and transmit the plurality of the ranked crowdfunding proposals to client device 335. The highest ranked crowdfunding proposal may be transmitted to client device 335 first. For example, the plurality of ranked crowdfunding proposals may be transmitted sequentially to client device 335 or in a predetermined arrangement.

As described above, recommendation engine 350 may be configured to identify or match users of client device 335 based on a plurality of user characteristics and application of one or more thresholds to the one or more plurality of user characteristics. Plurality of user characteristics may be retrieved by recommendation engine 350 from database 355. For example, FIG. 3B illustrates a plurality of users 360, 365, 370 that are identified or matched likely to favor or contribute to a particular crowdfunding proposal 380, 385, 390. Plurality of users 360, 365, 370 may be matched with same or different crowdfunding proposals 380, 385, 390.

In one example, user 360 may be identified as likely to favor a food business and accordingly matched with crowdfunding proposal 360 that serves a food card business venture requiring $40,000 funding by the second quarter of 2019 with 50% profit sharing. In this manner, user 360 may invest in crowdfunding proposal 360 and be charged a designated amount to his or her credit card. User 365 may be identified as likely to favor coffee shops and accordingly matched with crowdfunding proposal 385 that serves a coffee shop business venture requiring $20,000 funding by quarter of 2018 with 40% profit sharing. In this manner, user 365 may invest in crowdfunding proposal 385 and charged a designated amount to his or her credit card. User 370 may be identified as likely to favor a flower shop and accordingly matched with crowdfunding proposal 390 that serves a florist business venture requiring $15,000 funding by quarter one of 2019 with 30% profit sharing. In this manner, user 370 may invest in crowdfunding proposal 390 and charged a designated amount to his or her credit card.

System 301 may comprise a server 375 which hosts crowdfunding proposals 380, 385, 390.

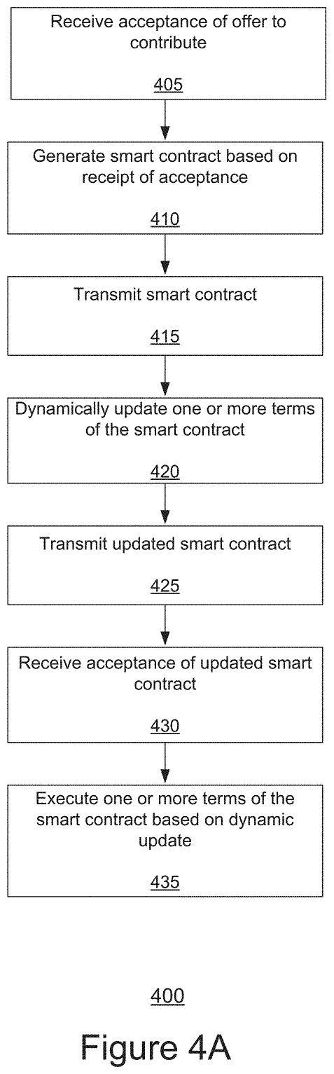

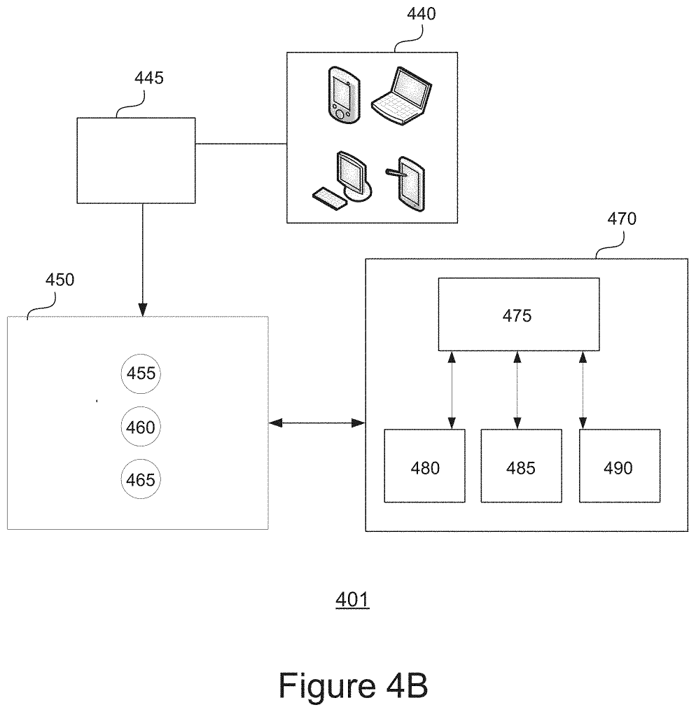

FIG. 4A illustrates an example method 400 of smart contract generation and processing. The smart contract generation may reference same or similar components and/or processes as described above with respect to FIG. 1 and FIG. 2.

At block 405, one or more processors may be configured to receive acceptance of an offer to contribute. For example, the receipt of acceptance of offer to contribute may be transmitted from a first device, such as a client device (similar to client device 105 as described above with respect to FIG. 1). In some examples, the acceptance of offer to contribute may be associated with the identified crowdfunding proposal based on one or more user characteristics and application of one or more thresholds to the one or more user characteristics.

At block 410, a smart contract may be generated, by one or more processors, responsive to receipt of acceptance of offer to contribute. For example, the acceptance of an offer to contribute may be received from the first device. In some examples, the generated smart contract may be between the user of the client device, such as an account holder, and the small business owner.

At block 415, the one or more processors may be configured to transmit the smart contract to the client device. For example, the client device may receive the transmitted smart contract and respond with an acceptance of the smart contract.

At block 420, one or more terms of the smart contract may be dynamically updated, by the one or more processors. For example, the smart contract may include one or more terms that are dynamically updated based on one or more changes associated with one or more of the account data and the transaction data prior to the receipt of the user's acceptance. The one or more processors of may be configured to collect funds upon execution of the smart contract. For example, the one or more terms may be adjusted include payment amount, payment date, payment frequency, and interest rate.

At block 425, after the smart contract is updated, the updated smart contract may be transmitted to the client device for acceptance.

At block 430, the one or more processors may be configured to receive acceptance of the updated smart contract from the client device.

At block 435, one or more terms of the smart contract may be executed based on the dynamic update of the one or more terms. For example, upon execution of the smart contract, one or more cryptocurrencies may be exchanged for the offer to contribute. In one example, the one or more cryptocurrencies may comprise one or more bitcoin transactions through blockchain implementation. For example, payment to user of the client device may comprise one or more cryptocurrencies in exchange for the offer to contribute. The payment may comprise a single payment or a plurality of periodic payments (e.g. weekly, bi-weekly, monthly, etc.). Different modes of payment may be made by user of the client device. In some examples, prior to transfer, currency may be converted to a cryptocurrency to enable cryptocurrency processing and exchange from a credit card account or bank account. In some examples, conversion may be performed after establishing communication with one or more servers, such as a trading platform, such that the one or more servers may be configured to receive a request from the client device to process conversion to a cryptocurrency based on corresponding conversion rates, cryptocurrency availability and liquidity, and other transaction-related cryptocurrency data. Thus, the client device may be configured to enable payment from a user account, such as a bank or credit card account, so as to process a cryptocurrency transaction to perform one or more modes of payment.

In one example, a crowdfunding proposal by a small business owner may seek $10,000 to open up a coffee shop via crowdfunding that services both small business owners and account holders. For example, 100 lenders, such as users of a client device, may each contribute $100 so as to satisfy the threshold amount. The $100 may be presented as a charge to a user of the client device. When the target threshold amount has been reached, the $10,000 may be released to the small business owner. As a consequence, the risk for lending via crowdfunding may be mitigated or reduced, and small business owners will no longer find it difficult to obtain secure venture capitalists for a small venture. Thus, there exists the incentive for a user of the client device to invest in a small venture. Moreover, there is an increased likelihood that small dollar investments will attract attention venture capitalists or other sources of funds.

FIG. 4B illustrates a system 401 according to an example of the present disclosure configured for smart contract generation. As explained below, system 401 may reference same or similar components of system 100.

System 401 may comprise one or more client devices 440 (similar to client device 105 as described above with respect to FIG. 1). As described above, one more client devices 440 may be required to comply with opt-in service 445. For example, users of client device 440 may have to first opt-in in order to view the crowdfunding proposals. For example, a user of client device 440 may opt-in via subscription or login process 445 by providing authentication information through client device 440. Upon validation of the authenticated information from the user or client device 440 or upon authenticating the user or client device 440, the crowdfunding proposals may be provided to the user or client device 440. In other examples, a user of client device 440 may not be required to opt-in and provide authentication information in order to view the crowdfunding proposals. In some examples, authentication of the user or client device 440 may not be required for the user to view the crowdfunding proposals. For example, a user may be notified via a notification, such as a pop-up notification, that appears on client device 440 indicative of the crowdfunding proposals (not shown).

System 401 may comprise a server 450 that includes a plurality of user investors 455, 460, 465. Plurality of user investors 455, 460, 465 may be in a smart contract with respective owners of crowdfunding proposals 480, 485, 490 via smart contract system 475.

Smart contract system 475 may comprise one or more processors configured to create a smart contract with one or more terms associated with instant profit-sharing for each of crowdfunding proposals 480, 485, 490. In some examples, the one or more terms of the smart contract may be adjusted prior to acceptance of the offer.

System 401 may comprise a server 470 that hosts smart contract system 475 and crowdfunding proposals 480, 485, 490.

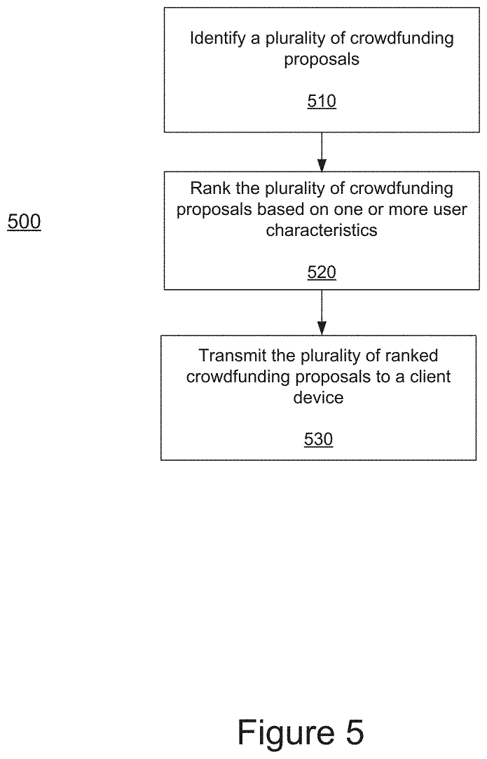

FIG. 5 illustrates a method 500 of operation of a recommendation engine.

Method 500 may method 200 may reference same or similar components of FIG. 1.

At block 510, one or more processors may be configured to operate a recommendation engine that is configured to identify a plurality of crowdfunding proposals.

At block 520, the recommendation engine may be configured to rank the plurality of crowdfunding proposals based on one or more user characteristics. For example, the recommendation engine may be configured to rank the plurality of crowdfunding proposals based on transaction data. In some examples, the recommendation engine may be configured to rank the plurality of crowdfunding proposals for relevance to the user based on transaction data.

At block 530, the recommendation engine may be configured to transmit the plurality of ranked crowdfunding proposals to a client device. For example, the recommendation engine may be configured to transmit the plurality of ranked crowdfunding proposals sequentially to a client device or in a predetermined arrangement. In some examples, the highest-ranked crowdfunding proposal is transmitted to the client device first.

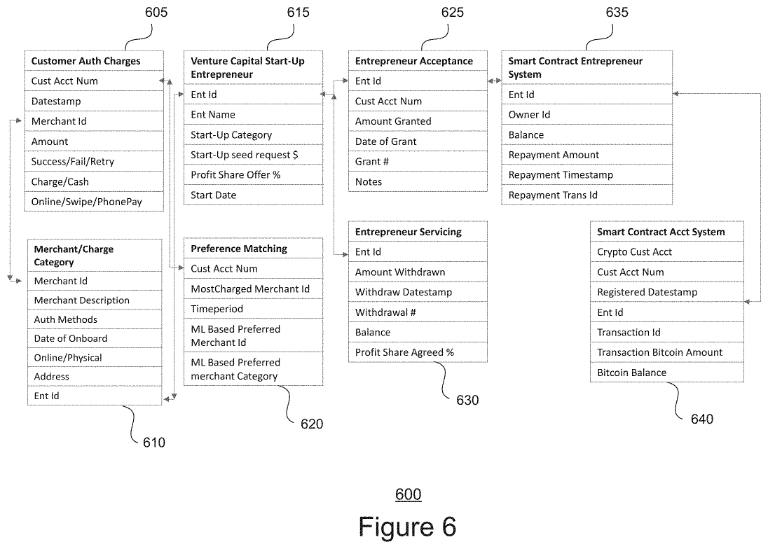

FIG. 6 illustrates database schema 600 for providing secure distributed crowdfunding according to example of the present disclosure. For example, database schema 600 may comprise one or more parameters for providing secure distributed crowdfunding: customer authentication charges 605; merchant/charge category 610; venture capital start-up entrepreneur 615; preference matching 620; entrepreneur acceptance 625; entrepreneur servicing 630; smart contract entrepreneur system 635; and smart contract account system 640. Each parameter may have one or more fields related to it, and it is understood that the field illustrated in FIG. 6 are exemplary and non-limiting. In some examples, the one or more parameters may be retrieved from one or more databases and may be called to perform one or more functions.

Customer authorization charges 605 may comprise a plurality of fields, including customer account number, date stamp of a transaction, merchant identification, amount of the transaction, status of the transaction (for example, whether it was successful, failed, or retry), type of transaction (for example, charge or cash), and type of payment (for example, online, card swipe, or mobile payment).

Merchant/Charge category 610 may comprise a plurality of fields, including merchant identification, merchant description, authentication methods, date of onboard, online/physical, address, and entry identification.

Venture capital start-up entrepreneur 615 may comprise a plurality of fields, including entry identification, entry name, start-up category, start-up seed request amount, profit share offer percentage, and start date. For example, venture capital start-up entrepreneur 615 may comprise data associated with providing crowdfunding proposals.

Preference matching 620 may comprise a plurality of fields, including customer account number, most charged merchant identification, time period, machine learning-based preferred merchant identification, and machine learning-based preferred merchant category. For example, preference matching 620 may comprise data associated with all preferences of customers.

Entrepreneur acceptance 625 may comprise a plurality of fields, including entry identification, customer account number, amount granted, date of grant, grant number, and notes. For example, entrepreneur acceptance 625 may comprise data associated with all information about the small business owner or entrepreneur and funding information.

Entrepreneur servicing 630 may comprise a plurality of fields, including entry identification, amount withdrawn, withdrawal timestamp, withdrawal number, balance, and profit share agreed percentage. For example, entrepreneur servicing 630 may comprise data associated with funding withdrawal information.

Smart contract entrepreneur system 635 may comprise a plurality of fields, including entry identification, owner identification, balance, repayment amount, repayment timestamp, and repayment transaction identification. For example, smart contract entrepreneur system may comprise data associated with all smart contracts, and entries associated with corresponding amounts for exchange.

Smart contract account system 640 may comprise a plurality of fields, including cryptocurrency customer account, customer account number, registered date stamp, entry identification, transaction identification, transaction bitcoin amount, and bitcoin balance, For example, smart contract account system 640 may comprise data associated with tracking customer bitcoin information.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A crowdfunding system comprising:
one or more databases stored in a memory, the one or more databases containing a plurality of user characteristics and a plurality of crowdfunding proposals, the plurality of user characteristics including transaction frequency, likelihood of interest, and transaction history, wherein the plurality of crowdfunding proposals are retrieved from the one or more databases based on one or more parameters including purchase authorization at one or more merchant locations; and
one or more processors, configured to:
operate a recommendation engine to identify a crowdfunding proposal from the plurality of crowdfunding proposals for presentation to a client device application comprising instructions for execution on a client device associated with a user based on the plurality of user characteristics stored in the one or more databases and the application of one or more thresholds to the plurality of user characteristics, wherein the recommendation engine is configured to provide a first set of the plurality of crowdfunding proposals to the client device application via preference matching such that the first set, based on the plurality of user characteristics, is provided as recommendations, wherein the recommendation engine is configured to adjust one or more criteria including at least one selected from the group of a payment mode and payment schedule associated with the identified crowdfunding proposal;
transmit the identified crowdfunding proposal to the client device application and one or more offers for contribution towards compliance with the identified crowdfunding proposal, wherein the compliance includes a predetermined threshold amount and time duration associated with the identified crowdfunding proposal; and
generate, upon receipt of the user's acceptance of an offer to contribute from the client device application, a smart contract based on the offer to contribute and account data and transaction data associated with the user.

2. The crowdfunding system of claim 1, wherein one or more terms of the smart contract are dynamically updated based on one or more changes associated with the account data and the transaction data prior to the receipt of the user's acceptance.

3. The crowdfunding system of claim 1, wherein the recommendation engine identifies a plurality of crowdfunding proposals, ranks the plurality of crowdfunding proposals for relevance to the user based on the transaction data, and transmits the plurality of ranked crowdfunding proposals sequentially to the client device application, wherein the highest-ranked crowdfunding proposal is transmitted to the client device application first.

4. The crowdfunding system of claim 1, wherein the recommendation engine identifies a plurality of crowdfunding proposals, ranks the plurality of crowdfunding proposals based on the plurality of user characteristics, and transmits the plurality of ranked crowdfunding proposals sequentially to the client device application, wherein the highest-ranked crowdfunding proposal is transmitted to the client device application first.

5. The crowdfunding system of claim 1, wherein the plurality of user characteristics is attributable to a specific user and includes at least one selected from the group of transaction frequency, likelihood of interest, user responses to surveys, amount being charged, and patterns of spending or transaction types.

6. The crowdfunding system of claim 1, wherein the one or more thresholds comprises at least one of authorization and weighting factors over a predetermined time period.

7. The crowdfunding system of claim 1, wherein the one or more processors are configured to convert a currency received from the client device application and associated with a user account to a cryptocurrency based on conversion rates in order to process the offer to contribute.

8. The crowdfunding system of claim 1, wherein the one or more processors are further configured to collect funds upon execution of the smart contract.

9. The crowdfunding system of claim 1, wherein the one or more processors are configured to present, to the client device application, one or more suggestive crowdfunding proposals via one or more machine learning algorithms by determining one or more patterns that match with the identified crowdfunding proposal.

10. The crowdfunding system of claim 1, wherein the one or more terms of the smart contract include one or more adjustable terms associated with modes of payment.

11. A method comprising:
identifying, by one or more processors, a crowdfunding proposal from a plurality of crowdfunding proposals based on at least one of authorization and weighting factors over a predetermined time period, the authorization and weighting factors being associated with a plurality of user characteristics including transaction frequency, likelihood of interest, and transaction history, the plurality of crowdfunding proposals and authorization and weighting factors contained in one or more databases stored in memory, wherein the plurality of crowdfunding proposals are retrieved from the one or more databases based on one or more parameters including purchase authorization at one or more merchant locations;
providing, by the one or more processors to a first device application comprising instructions for execution on a first device, the crowdfunding proposal and one or more offers for contribution towards compliance with the crowdfunding proposal, wherein the compliance includes a predetermined threshold amount and time duration associated with the crowdfunding proposal, wherein a first set of the plurality of crowdfunding proposals is provided to the client device application via preference matching such that the first set, based on the plurality of user characteristics, is provided as recommendations, wherein the one or more processors are configured to adjust one or more criteria including at least one selected from the group of a payment mode and payment schedule associated with the identified crowdfunding proposal;
receiving, by the one or more processors, an acceptance of an offer to contribute from the first device application;
creating, by the one or more processors, one or more smart contracts responsive to the receipt of the acceptance of the offer to contribute from the first device application;
updating, by the one or more processors, one or more terms of the one or more smart contracts based on one or more changes of account data and transaction data associated with the user; and
collecting, by the one or more processors, funds as required by at least one of the one or more smart contracts and updated one or more smart contracts.

12. The method of claim 11, further comprising authenticating, by the one or more processors, the first device application prior to receipt of the acceptance of the offer to contribute from the first device application.

13. The method of claim 11, wherein the crowdfunding proposal comprises a business venture, and further comprising collecting, by the one or more processors, funds from the business venture in accordance with the one or more smart contracts.

14. The method of claim 13, further comprising distributing, by the one or more processors, the funds collected from the business venture to an account associated with the user.

15. The method of claim 13, further comprising distributing, by the one or more processors, a predetermined percentage of the funds collected from the business venture to an account not associated with the user.

16. The method of claim 11, further comprising ranking, by the one or more processors, the plurality of crowdfunding proposals for relevance to the user based on the transaction data, and
wherein a first set of data provided to the first device application includes the highest-ranked crowdfunding proposal such that the highest-ranked crowdfunding proposal is provided to the first device application prior to providing the plurality of ranked crowdfunding proposals sequentially to the first device application.

17. The method of claim 11, wherein the plurality of user characteristics is compiled from data collected from a plurality of users.

18. The method of claim 11, further comprising providing, by the one or more processors, one or more predictive suggestions via machine learning based on the identified data crowdfunding proposal.

19. The method of claim 11, wherein the one or more terms of the one or more smart contracts are adjusted by the user prior to the acceptance of the offer.

20. A non-transitory computer-readable medium storing instructions that, when executed by at least one processor, cause the at least one processor to:
provide, based on authenticated login information, a crowdfunding proposal from a plurality of crowdfunding proposals to a client device application comprising instructions for execution on a client device associated with a user based on a plurality of parameters, the plurality of parameters including transaction frequency, likelihood of interest, and transaction history, wherein a first set of the plurality of crowdfunding proposals is provided to the client device application via preference matching such that the first set, based on the plurality of user characteristics, is provided as recommendations, wherein the plurality of crowdfunding proposals are retrieved from one or more databases based on purchase authorization at one or more merchant locations;
adjust one or more criteria including at least one selected from the group of a payment mode and payment schedule associated with the identified crowdfunding proposal;
provide, to the client device application, one or more ranked predictive suggestions associated with the plurality of crowdfunding proposals via machine learning based on the plurality of parameters;
create a smart contract based on receipt of an acceptance of an offer for contribution towards compliance with the identified crowdfunding proposal, wherein the compliance includes a predetermined threshold amount and time duration associated with the identified crowdfunding proposal; and
exchange one or more cryptocurrencies for the offer to contribute.
